(19) United States
(12) Patent Application Publication
(10) Pub. No.: US 2011/0129393 A1
(43) Pub. Date: Jun. 2, 2011

(54) Electrically-Heated Contact Fuel Vaporizer for a Hydrocarbon Reformer

(76) Inventors: Oscar A. Lecea, Grand Blanc, MI (US); James M. Ciosek, Davison, MI (US)

(21) Appl. No.: 12/629,519

(22) Filed: Dec. 2, 2009

(51) Int. Cl. B01J 19/00; F23D 5/18

(52) U.S. Cl. 422/187; 392/398; 431/208

(57) ABSTRACT

An improved electrically-heated contact vaporizer (EHCV) for a catalytic hydrocarbon reformer. The EHCV has an electrically-heated vaporization surface and a helical-wound flow director. Preferably the EHCV includes a port and internal passages to permit controlled entry of an oxygen-containing gas, preferably air, into a flowing stream of vaporized fuel near the exit of the EHCV to mix with the vaporized fuel and spontaneously combust, forming hot gases for heating the reforming catalyst. A third wall may be provided to surround the outer wall of the air passage to provide further thermal insulation against heat loss.

### TECHNICAL FIELD

The present invention relates to hydrocarbon reformers; more particularly, to apparatus for vaporizing fuel entering a hydrocarbon reformer; and most particularly, to an electrically heated contact fuel vaporizer (EHCV) for a reformer wherein a flow director extends into the vaporizing space to direct the flow of vapor and wherein, in one aspect of the invention, air may be introduced at start-up to cause spontaneous fuel combustion for warm-up of the reformer.

### BACKGROUND OF THE INVENTION

In the art of catalytic reforming of hydrocarbons to generate hydrogen, it is known to provide an EHCV apparatus ahead of the reforming catalyst to vaporize fuel for reforming. Subsequent to vaporization, the fuel typically is mixed with a controlled amount of air to provide an optimum fuel/air mixture for reforming, which mixture ratio is below the Lower Explosive Limit (LEL) for the particular fuel being used.

Especially upon startup of a reformer, a high thermal load is required to vaporize liquid fuel entering the reformer at ambient temperature. It is known to provide a vaporizer having a designated surface for vaporization of the fuel upon which the liquid fuel is impinged during operation of the reformer. Upon start-up, the surface must be heated by separate means, typically by an electrically-powered heater such as a glow plug or cartridge rod which is de-energized when a sufficient temperature increase is achieved. At equilibrium reformer operating temperatures, the surface typically receives sufficient waste heat to achieve reliable vaporization without further supplemental heating.

In the prior art, ECHVs for vaporizing diesel fuel have used different methods to add heat to the fuel, typically a metering device that flows fuel to an open ended heating chamber consisting of a thin wall tube with the cartridge rod heater centered inside. The tube and heater forms an annulus about 1.0 mm in radial size extending the length of the working portion of the rod heater. The open end (outlet end) delivers the heated fuel in vapor form to a mixing chamber of the reforming device where air is mixed with the fuel vapor for reforming.

Some disadvantages of such a prior art system are:

a) the EHCV is mounted by means of a dual ferrule fitting, welded to the high thermal mass end plate of the mixing chamber of the reformer. This mounting system creates a seal between the EHCV and the chamber but does not thermally isolate the two and creates an undesirably large contact area between the EHCV and the reformer. The thermal mass of the end plate creates a heat sink which cools the vapor, reducing the efficiency of the device;

b) the 1.0 mm annulus is too large even for the maximum required fuel flow of the application, which has the effect of minimizing surface contact between the liquid fuel and the rod heater and creates a thicker fluid film layer requiring longer residence time; the overly-large annulus also causes hot spots on the heater which are not being cooled by fuel or vapor, which impacts durability of the heater;

c) fuel vapor enters the mixing chamber at low velocity, adversely impacting air/fuel mixing;

d) the outer walls of the EHCV are exposed to cold reformer inlet air in the mixing chamber;

e) outer fuel heating chamber walls are cooled by convection, thereby wasting energy; cooled chamber walls condense vapor by conduction, and condensed vapor droplets cause the prior art EHCV to sputter liquid fuel;

f) because of the large annulus and multiple sources of heat loss, power requirement is high, typically about 400 W, and vaporized fuel output is relatively inefficient.

At startup of a reformer, the reforming catalyst must be heated to achieve catalyzing temperature, typically to about 500° C. It is known in the prior art to provide a spark or other igniter mechanism extending through a wall of the reformer into a combustion chamber between the prior art EHCV and the reforming catalyst. For a short period, a combustible fuel/air mixture is formed in the combustion chamber and ignited by the igniter, the hot combustion gases then passing through the reforming catalyst. When catalyzing temperature is reached, ignition is suspended and the fuel/air ratio is adjusted for reforming.

Providing an igniter in the hot zone of a reformer presents significant engineering and materials challenges. A standard automotive spark plug is not suitable as the continuously hot environment causes corrosion and failure, thus expensive or exotic materials of construction are required; a spark-ignition device is easily fouled by carbon deposits, leading to ignition failure; the igniter mounting requires additional bosses on the reformer housing, which are additionally expensive and undesirable; the igniter requires power to operate in addition to the power required for the EHCV; and the igniter itself adds to the cost and complexity of the reformer.

What is needed in the art is an EHCV that provides high-efficiency high-volume vaporizing of diesel fuel and also eliminates the need for a separate igniter in a hydrocarbon reformer.

It is a principal object of the present invention to vaporize fuel more efficiently.

It is a further object of the present invention to eliminate the need for a separate igniter in a hydrocarbon reformer being supplied by an improved EHCV in accordance with the present invention.

### SUMMARY OF THE INVENTION

Briefly described, an improved EHCV for a catalytic hydrocarbon reformer includes an electrically-powered rod heater surrounded by a first tube defining a first annulus therebetween. In one aspect of the invention, the first annulus is about 0.2 mm in radial dimension and having an open end defining an exit from the EHCV. A spiral flow director is disposed in the first annulus to direct flow of fuel and vapor in a helical path around the rod heater through the EHCV. A tubular insulative housing surrounds the first tube, preferably comprising an outer housing tube and a thermal barrier tube disposed between the outer housing tube and the first tube.

A first inlet port for introduction of liquid fuel at the inlet end of the EHCV extends through the insulative housing and the first tube into the first annulus to provide fuel to the heating rod for vaporization.

In one aspect of the invention, the helical path for directing the flow of fuel through the EHCV may be formed as a channel in either the internal surface of the first tube, the outer surface of the rod heater, or partially in both. Further, multiple rod heaters may be chained in parallel with one or more cross-passages connecting the heaters, fluidically, to increase the heating capacity of the EHCV.

In a second embodiment useful in reformers having no combustion igniter, a second inlet port and internal passages including a second annulus between the thermal barrier tube and the first tube permit controlled entry of oxygen, preferably in the form of air, into the first annulus near the exit end thereof to mix with hot, vaporized fuel exiting the vaporizer, thereby creating a fuel/air mixture above the LEL which spontaneously combusts to form hot gases for heating the reforming catalyst as in the prior art. When a sufficient temperature is achieved in the reformer, air flow into the EHCV is suspended, extinguishing combustion, and fuel flow rate is adjusted for reforming.

### BRIEF DESCRIPTION OF THE DRAWINGS

The present invention will now be described, by way of example, with reference to the accompanying drawings, in which:

FIG. 1 is a longitudinal cross-sectional view of a first embodiment of an improved EHCV in accordance with the present invention;

FIG. 2 is a perspective cutaway view of a portion of a first embodiment similar to the embodiment shown in FIG. 1;

FIG. 3 is a sectioned view of a variation of the tubular housing shown in FIG. 1 in accordance with the invention;

FIG. 4 is a cross-sectional view of a second embodiment of an improved EHCV in accordance with the present invention;

FIG. 5 is a perspective view, partially in cutaway, of the second embodiment shown in FIG. 4; and

FIG. 6 is simplified schematic drawing showing control and incorporation of the improved EHCV into a catalytic hydrocarbon reformer.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

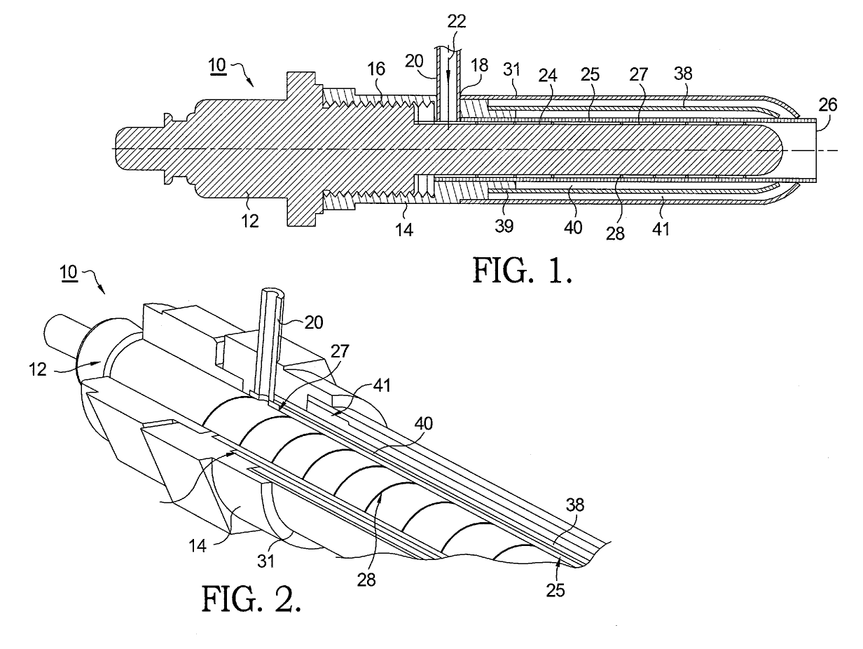

Referring to FIGS. 1 and 2, a first embodiment 10 of an improved EHCV in accordance with the present invention comprises an electrically-powered heating element 12, for example, a glow plug or rod heater, disposed in a tubular housing 14 and preferably connected thereto by mating threads 16. A first port 18 in housing 14 contains a first nipple 20 for delivering liquid hydrocarbon fuel 22 for vaporization on surface 24 of element 12.

Fuel flows along heater surface 24, confined by a concentric first tube 25 in a first annular flow space 27 and is discharged at exit 26 into a mixing chamber ahead of a catalytic hydrocarbon reformer. In radial dimension, an annulus of flow space 27 is less than 1.0 mm, and preferably is about 0.2 mm, in contrast to a typical prior art EHCV wherein this dimension is about 1.0 mm. The reduced annulus height of flow space 27 results in faster heating of a thinner layer of fuel.

A flow director 28, which may take the form of a helical wire or a raised helical rib on heating element 12 or on an ID of first tube 25, is disposed in flow space 27 and causes fuel and fuel vapor to follow a helical path through flow space 27, which path serves to prevent channeling as is known to occur in prior art EHCV devices, thus defining a longer contact path for fuel against surface 24 and distributing fuel and fuel vapor more evenly over surface 24, thereby preventing formation of undesirable hot spots. Further, fuel vapor exits EHCV 10 with a swirling motion, thus improving mixing with introduced air in the mixing chamber. The spiral pattern of flow director 28 may be formed having a constant pitch as shown in FIG. 2, or having a varied pitch (not shown) to further optimize fuel vaporization.

In one aspect of the invention, tube 25 is formed, at least in part, of an insulative material to minimize heat losses from the heated fuel.

Preferably, an outer tubular wall 31 defining a housing extension is swaged or otherwise attached to housing 14 and closes against first tubular wall 25 near the exit end thereof. Outer tubular wall 31 may be a low mass structural member for sealing the vaporizer while minimizing parasitic heat transfer it because of its low mass structure.

A second tubular wall 38 may extend longitudinally from housing 14, as for example, from a step 39 in housing 14 as shown in FIG. 1. In one aspect of the invention, wall 38 is also closed against first tubular wall 25 near the exit end thereof. Preferably, wall 38 is formed of an insulative material to reduce radiative heat loss from heater 12 and to act as an infrared energy reflector. Preferably, wall 38 is separated from both outer tubular wall 31 and first tubular wall 25, defining first and second insulative captive air annuli 40,41.

Preferably, in mounting the EHCV to a reformer, the contact area between the EHCV and the reformer is reduced in comparison to prior art mountings to minimize heat loss from the EHCV.

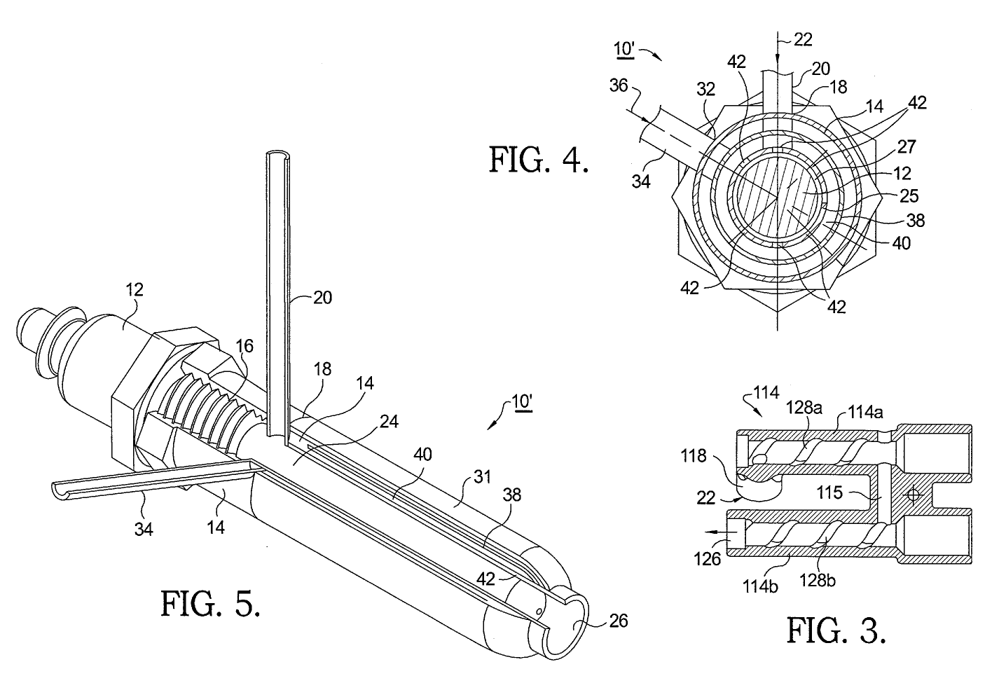

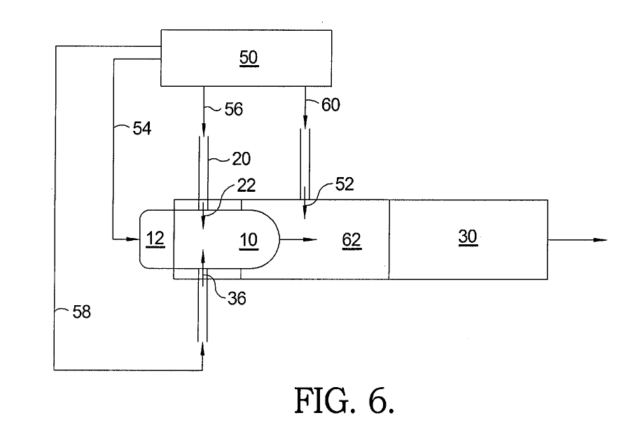

Referring to FIG. 3, housing 114 of a variation of the embodiment shown in FIGS. 1 and 2 is disclosed. First and second glow plugs or rod heaters (not shown) are disposed in housing branches 114a and 114b similar to the singular rod heater shown in FIGS. 1 and 2. A first port 118 in housing 114 is provided for delivering liquid hydrocarbon fuel 22 to first housing branch 114a for vaporization. Helical flow channel 128a, formed in the internal surface of branch 114a as shown, or in the outer surface of the rod heater (not shown) causes fuel and fuel vapor to follow a helical path through branch 114a in contact with the rod heater. The fuel and fuel vapor then passes through cross-passage 115, and follows a second helical flow channel 128b in branch 114b for further vaporization, thereafter being discharged at exit 126 into a mixing chamber ahead of a catalytic hydrocarbon reformer. With respect to this variation, helical flow channels 128a,128b may be formed partially in the internal surfaces of the housing and partially in the outer surfaces of the rod heaters.

Referring now to FIGS. 3 and 4, in a second embodiment 10′ of an EHCV improved in accordance with the present invention, a second port 32 in housing 14 contains a second nipple 34 for injecting a combustible gas 36, such as an oxygen-containing gas such as for example, air, into the EHCV. Nipple 34 extends to air annulus 40. A plurality of radial openings 42, for example, six, are provided in first tubular wall 25 near the exit end thereof, connecting air annulus 40 with flow space 27 and thus permitting mixing of injected combustible gas 36 into the vaporized fuel just as the vapor exits the EHCV and further permitting the mixture to impinge on the end of heating element 12. When a fuel/air ratio above the LEL is formed in the hot, vaporized fuel, spontaneous combustion of the fuel/air mixture occurs in the reformer mixing chamber, providing hot combustion gases for heating the reformer catalyst.

Referring now to FIG. 5, operation of either EHCV 10 or EHCV 10′ is controlled by a control apparatus 50, for example a programmable controller or a computer, referred to herein generically as “controller”. Controller 50 is programmed with a plurality of algorithms for sending signals controlling energizing and de-energizing of heating element 12, flow of liquid fuel 22, flow of combustible gas 36, and flow of reforming air 52 (signals 54,56,58,60, respectively). (Note that in use of first embodiment 10, combustible gas 36 may be metered directly into chamber 28 rather than into the EHCV as shown in FIG. 5 for embodiment 10′).

In operation of either EHCV 10 or EHCV 10′, whenever vaporized fuel is required and the temperature of surface 24 is below a predetermined lower limit, heating element 12 is energized to raise the temperature of surface 24. When the ambient temperature in EHCV 10 or 10′ is sufficient to maintain vaporization of fuel, heating element is de-energized.

In operation of EHCV 10′, when the temperature within reformer 30 is insufficient to cause reforming catalysis of vaporized fuel, combustible gas 36 is injected through openings 42, forming a combustible fuel/air mixture that combusts spontaneously in chamber 62 to form hot gases that are passed through reformer 30. When the reformer attains catalysis temperature, flow of combustible gas 36 is terminated, and flow of reforming air 52 is adjusted to provide an optimal fuel/air mixture for reforming.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An electrically-heated contact vaporizer for vaporizing liquid hydrocarbon fuel, comprising:
a) an electrically-heated element having an evaporation surface;
b) a tube surrounding said electrically-heated element to define an annular flow space therebetween and having an entrance for said liquid hydrocarbon fuel to said annular flow space and an exit for vaporized hydrocarbon fuel from said annular flow space,
wherein the radial dimension of an annulus defining said annular flow space is less than 1.0 mm.

2. A vaporizer in accordance with claim 1 wherein said radial dimension is about 0.2 mm.

3. A vaporizer in accordance with claim 2 wherein said tube is an insulative element.

4. A vaporizer in accordance with claim 1 further comprising an inlet port in flow communication with said annular flow space.

5. A vaporizer in accordance with claim 4 further comprising a passage configured for supplying a combustible gas to said vaporized hydrocarbon fuel to cause ignition of said vaporized hydrocarbon fuel.

6. A vaporizer in accordance with claim 5 wherein said tube, annular flow space, and inlet port are a first tube, a first annular flow space, and a first inlet port, and wherein said passage for supplying said combustible gas comprises:
a) a second tube radially off-spaced from said first tube defining a second annular flow space therebetween;
b) a second inlet port in flow communication with said second annular flow space; and
c) an apparatus for controlling flow of said combustible gas into said second annular flow space.

7. A vaporizer in accordance with claim 5 wherein said combustible gas is oxygen.

8. A vaporizer in accordance with claim 5 further comprising a flow director disposed within said first annular flow space to direct flow of fuel through said first annular flow space.

9. A vaporizer in accordance with claim 8 wherein said flow director is configured to divert flow of fuel through said annular flow space from a direction longitudinal of said annular flow space over at least a longitudinal portion of said annular flow space.

10. A vaporizer in accordance with claim 8 wherein said flow director is helical in form.

11. A vaporizer in accordance with claim 10 wherein a pitch of said helical form is constant.

12. A vaporizer in accordance with claim 10 wherein a pitch of said helical form is variable.

13. A vaporizer in accordance with claim 10 wherein said flow of fuel defines a helical path along said evaporation surface of said electrically-heated element.

14. A vaporizer in accordance with claim 1 further comprising a flow director disposed within said first annular flow space to direct flow of fuel through said first annular flow space.

15. A vaporizer in accordance with claim 14 wherein said flow director is configured to divert flow of fuel through said annular flow space from a direction longitudinal of said annular flow space over at least a longitudinal portion of said annular flow space.

16. A vaporizer in accordance with claim 14 wherein said flow director is helical in form.

17. A vaporizer in accordance with claim 16 wherein a pitch of said helical form is constant.

18. A vaporizer in accordance with claim 16 wherein a pitch of said helical form is variable.

19. A vaporizer in accordance with claim 15 wherein said flow of fuel defines a helical path along said evaporation surface of said electrically-heated element.

20. A vaporizer in accordance with claim 6 comprising a third tube radially off-spaced from said second tube and supportive of said vaporizer.

21. A catalytic hydrocarbon reformer comprising an electrically-heated contact vaporizer for vaporizing liquid hydrocarbon fuel, said vaporizer including:
a) an electrically-heated element having an evaporation surface;
b) a tube surrounding said electrically-heated element to define an annular flow space therebetween and having an entrance for said liquid hydrocarbon fuel to said annular flow space and an exit for vaporized hydrocarbon fuel from said annular flow space,
wherein the radial dimension of an annulus defining said annular flow space is less than 1.0 mm.

22. A reformer in accordance with claim 21 further comprising a passage configured for supplying a combustible gas to said vaporized hydrocarbon fuel to cause ignition of said vaporized hydrocarbon fuel.

23. A reformer in accordance with claim 22 further comprising a flow director disposed within said first annular flow space to direct flow of fuel through said first annular flow space.

24. A catalytic hydrocarbon reformer comprising an electrically-heated contact vaporizer for vaporizing liquid hydrocarbon fuel, said vaporizer including:
a) an electrically-heated element having an evaporation surface;
b) a tube surrounding said electrically-heated element to define an annular flow space therebetween and having an entrance for said liquid hydrocarbon fuel to said annular flow space and an exit for vaporized hydrocarbon fuel from said annular flow space; and
c) a passage configured for supplying a combustible gas to said vaporized hydrocarbon fuel to cause ignition of said vaporized hydrocarbon fuel.

25. An electrically-heated contact vaporizer for vaporizing liquid hydrocarbon fuel, comprising:
a) an electrically-heated element having an evaporation surface;
b) a tube surrounding said electrically-heated element to define an annular flow space therebetween and having an entrance for said liquid hydrocarbon fuel to said annular flow space and an exit for vaporized hydrocarbon fuel from said annular flow space; and
c) a passage configured for supplying a combustible gas to said hydrocarbon fuel to cause ignition of said vaporized hydrocarbon fuel.

26. A vaporizer in accordance with claim 25 wherein said tube, annular flow space, and inlet port are a first tube, a first annular flow space, and a first inlet port, and wherein said conductor comprises:
a) a second tube radially off-spaced from said first tube defining a second annular flow space therebetween;
b) a second inlet port in flow communication with said second annular flow space; and
c) an apparatus for controlling flow of said combustible gas into said second annular flow space.

27. A vaporizer in accordance with claim 25 wherein said combustible gas is oxygen.

28. A vaporizer in accordance with claim 25 further comprising a flow director disposed within said first annular flow space to direct flow of fuel through said first annular flow space.

29. A vaporizer in accordance with claim 28 wherein said flow director is configured to divert flow of fuel through said annular flow space from a direction longitudinal of said annular flow space over at least a longitudinal portion of said annular flow space.

30. A vaporizer in accordance with claim 28 wherein said flow director is helical in form.

31. A vaporizer in accordance with claim 30 wherein a pitch of said helical form is constant.

32. A vaporizer in accordance with claim 30 wherein a pitch of said helical form is variable.

33. A vaporizer in accordance with claim 28 wherein said flow of fuel defines a helical path along said evaporation surface of said electrically-heated element.

34. A vaporizer in accordance with claim 26 comprising a third tube radially off-spaced from said second tube and supportive of said vaporizer.

35. A catalytic hydrocarbon reformer comprising an electrically-heated contact vaporizer for vaporizing liquid hydrocarbon fuel, wherein said vaporizer includes:
a) an electrically-heated element having an evaporation surface;
b) a tube surrounding said electrically-heated element to define an annular flow space therebetween and having an entrance for said liquid hydrocarbon fuel to said annular flow space and an exit for vaporized hydrocarbon fuel from said annular flow space; and
c) a passage configured for supplying a combustible gas to said vaporized hydrocarbon fuel to cause ignition of said vaporized hydrocarbon fuel.

36. A reformer in accordance with claim 35 further comprising a flow director disposed within said first annular flow space to direct flow of fuel through said first annular flow space.

37. An electrically-heated contact vaporizer for vaporizing liquid hydrocarbon fuel, comprising:
a) an electrically-heated element having an evaporation surface;
b) a tube surrounding said electrically-heated element to define an annular flow space therebetween and having an entrance for said liquid hydrocarbon fuel to said annular flow space and an exit for vaporized hydrocarbon fuel from said annular flow space; and
c) a flow director disposed within said first annular flow space to direct flow of fuel through said first annular flow space.

38. A vaporizer in accordance with claim 37 wherein said flow director is configured to divert flow of fuel through said annular flow space from a direction longitudinal of said annular flow space over at least a longitudinal portion of said annular flow space.

39. A vaporizer in accordance with claim 37 wherein said flow director is helical in form.

40. A vaporizer in accordance with claim 39 wherein a pitch of said helical form is constant.

41. A vaporizer in accordance with claim 39 wherein a pitch of said helical form is variable.

42. A vaporizer in accordance with claim 37 wherein said flow of fuel defines a helical path along said evaporation surface of said electrically-heated element.

43. A catalytic hydrocarbon reformer comprising an electrically-heated contact vaporizer for vaporizing liquid hydrocarbon fuel, wherein said vaporizer includes:
a) an electrically-heated element having an evaporation surface;
b) a tube surrounding said electrically-heated element to define an annular flow space therebetween and having an entrance for said liquid hydrocarbon fuel to said annular flow space and an axial exit for vaporized hydrocarbon fuel from said annular flow space; and
c) a flow director disposed within said first annular flow space to direct flow of fuel through said first annular flow space.
